(19) United States
(12) Patent Application Publication
(10) Pub. No.: US 2002/0080035 A1
(43) Pub. Date: Jun. 27, 2002

(54) System for awaking a user

(76) Inventor: Konstantin Youdenko, Eindhoven (NL)

Correspondence Address: Corporate Patent Counsel, U.S. Philips Corporation, 580 White Plains Road, Tarrytown, NY, 10591, US

(21) Appl. No.: 09/885,699

(22) Filed: Jun. 20, 2001

(30) Foreign Application Priority Data
Jun. 22, 2000 (EP) 00202171.5

(51) Int. Cl. G08B 23/00

(52) U.S. Cl. 340/573.1; 340/540

(57) ABSTRACT

The invention relates to an alarm clock system. The system according to the invention comprises sensor means for measuring ambient parameters. In particular, a user's body parameters are monitored so as to determine in which stage of sleep he is. Properties of the wake-up stimulus, such as sound volume of the stimulus or moment of generation of the stimulus, are adjusted in dependence on the inferred stage of sleep.

### FIELD OF THE INVENTION

The invention relates to a system for waking a user, comprising alarm means for generating a stimulus for waking the user. The invention further relates to an alarm clock for use in the above system.

### BACKGROUND OF THE INVENTION

An example of the system as defined above is the well-known clock alarm. Such a clock alarm allows a user to set a time at which the user wishes to be awaked. At the time set by the user, the clock alarm produces an auditory signal, e.g. a buzz or the sound of a radio program, which awakes the user.

### OBJECT AND SUMMARY OF THE INVENTION

It is an object of the invention to provide an improved system of the type defined in the opening paragraph. To that end, the system according to the invention is characterized in that the system further comprises sensor means for measuring an ambient parameter, the alarm means being adapted to adjust at least one attribute of said stimulus on the basis of a value of said ambient parameter. In this way it is achieved that the system according to the invention takes ambient parameters into account for determining the way the user is awaked. The invention is based on the insight that the optimal way of awaking a person may depend on certain parameters external to the system. In particular, body parameters of the user may influence the ease of waking up and the user's functioning during the day after such awaking. Sleep research has revealed that sleep is an active, highly organized sequence of events and physiological conditions. Sleep is actually made up of two separate and distinctly different states: ‘non-rapid eye movement sleep’ (NREM sleep) and ‘rapid eye movement sleep’ (REM sleep) or dreaming sleep. The NREM and REM types of sleep differ from one another as much as they differ from the awake state.

NREM sleep is further divided into stages 1-4 based on the size and speed of the brain waves generated by the sleeper. Stages 3 and 4 of NREM sleep have the biggest and slowest brain waves. These big, slow waves are called delta waves and stages 3 and 4 sleep, combined, are often called ‘slow-wave sleep’ or ‘delta sleep’.

During REM sleep you can watch the sleeper's eyes move around beneath closed eyelids. Some scientists think that the eyes move in a pattern that relates to the visual images of the dream. We are almost completely paralyzed in REM sleep—only the heart, diaphragm, eye muscles and the smooth muscles (such as the muscles of the intestines and blood vessels) are spared from the paralysis of REM sleep.

Scientists have tried to determine what type of sleep is the deepest sleep. To do this, they measure how much noise or other alerting stimulation is required to awaken a sleeper from the various types of sleep. It is always possible to awaken someone who is sleeping, as opposed to, say someone who is in a coma. However, people in stages 3 and 4 sleep require the most stimulation to awaken. Therefore, this phase of sleep is often thought of as ‘deep sleep’. Also, large spurts of growth hormone are secreted during stages 3 and 4 NREM sleep. Consequently, these stages of sleep are thought to restore the body from the wear and tear of waking activity. People in REM sleep also tend to be quite difficult to awaken, but this finding is variable—sometimes even the slightest noise can awaken a person in REM sleep. Nevertheless, because it is often difficult to awaken a person from REM sleep, many scientists think also of REM sleep as a ‘deep’ phase of sleep.

The chart shown in FIG. 1 is called a hypnogram. Hypnograms are made to summarize sleep laboratory recordings. This particular hypnogram shows how a typical night's sleep for a young, healthy adult is organized. Notice how the night is structured into the various stages of NREM sleep alternating with REM sleep, with most slow-wave sleep occurring in the first part of the night and most REM sleep occurring in the last part. NREM and REM sleep alternate cyclically through the night. Except in certain pathological conditions, a night of sleep begins with about 80 minutes of NREM sleep, followed by a REM period of about ten minutes. This 90-minute NREM-REM cycle is then repeated about 3-6 times during the night. In the successive cycles of the night, the amounts of stages 3 and 4 decrease, and the proportion of the cycle occupied by REM sleep tends to increase. Extensive information about sleep research can be obtained at Pacific Sleep Medicine Services (www.sleepmedservices.com) and the Sleep Home Pages (www.sleephomepages.org).

It is an achievement of the present invention to provide a waking system which is capable of taking parameters of the type described above into account and of adjusting attributes of the wake-up stimulus accordingly. In particular, parameters may be measured which are representative of the user's stage of sleep. For example, a temperature sensor may measure the user's body temperature and infer the stage of sleep from it. Sleep research has revealed that body temperature is not regulated during REM sleep. Therefore, shivering in response to a cold temperature stops during REM sleep as does sweating in response to a hot temperature. As a consequence, for as long as REM sleep persists, one's body temperature will drift toward the environmental temperature. Hence, by measuring the user's body temperature, and comparing it with the environmental temperature, the system can infer the stage of sleep. For this purpose, a thermometer may be provided, e.g. integrated with bedclothes or based on infrared sensors for remote measurements. Alternatively, or additionally, other body parameters may be measured, such as heart rate, respiration rate, and blood pressure, galvanic skin activity, muscle tone or body mobility.

In dependence on the inferred stage of sleep, attributes of the wake-up stimulus may be adjusted. For example, if the system infers that the user is in NREM stage 3 or 4, the sound level may be increased in comparison with the sound level used in the other stages. As another example, the moment of waking may be varied within a certain time interval, to make it coincide with a particular stage of sleep. To this end, the wake-up time set by the user is interpreted as the time at which the user has to be waked at the latest. The system has a certain freedom to vary the exact waking moment, e.g. it may select an appropriate moment from a half-hour interval ending at the user selected waking time. Optionally, the length of this interval may be altered by the user, e.g. from a range of zero to sixty minutes.

For an accurate determination of the user's stage of sleep, it might be necessary to keep a record of various body parameters during a certain period before the wake-up time. For example, the system may record the body temperature as function of time, and infer the various stages from the resulting hypnogram. By comparing the temperature levels at various moments and mapping them on a general sleep model, e.g. the hypnogram of FIG. 1, the system may learn which temperatures are typical of a certain stage of sleep.

An embodiment of the system according to the invention is characterized by the system further comprising user operable means for determining during which stage of sleep the user is waked. The best moment for waking up a user may differ from person to person. Subjects awakened from NREM report that they had been in “lighter” sleep than when awakened from REM. This indicates that persons have less difficulty in waking up from NREM sleep, which results in a better functioning during the period after such waking. However, people may equally well prefer to be waked during REM sleep, e.g. because this enables them to more easily recall their dreams, or just because it makes them feel better afterwards. The present embodiment allows users to indicate during which kind of stage they want to be waked. For example, if the user prefers to be waked during REM sleep, the system will generate the waking stimulus as soon as a REM sleep stage occurs during the interval described hereinbefore.

### BRIEF DESCRIPTION OF THE DRAWINGS

These and other aspects of the invention are apparent from and will be elucidated, by way of a non-limitative example, with reference to the embodiment(s) described hereinafter. In the drawings,

FIG. 1 shows a hypnogram, comprising sequences of states and stages of sleep on a typical night,

FIG. 2 shows an alarm clock system as an example of a system according to the invention,

FIG. 3 shows a flow chart of the method of adjusting a wake-up time according to the invention.

### DESCRIPTION OF EMBODIMENTS

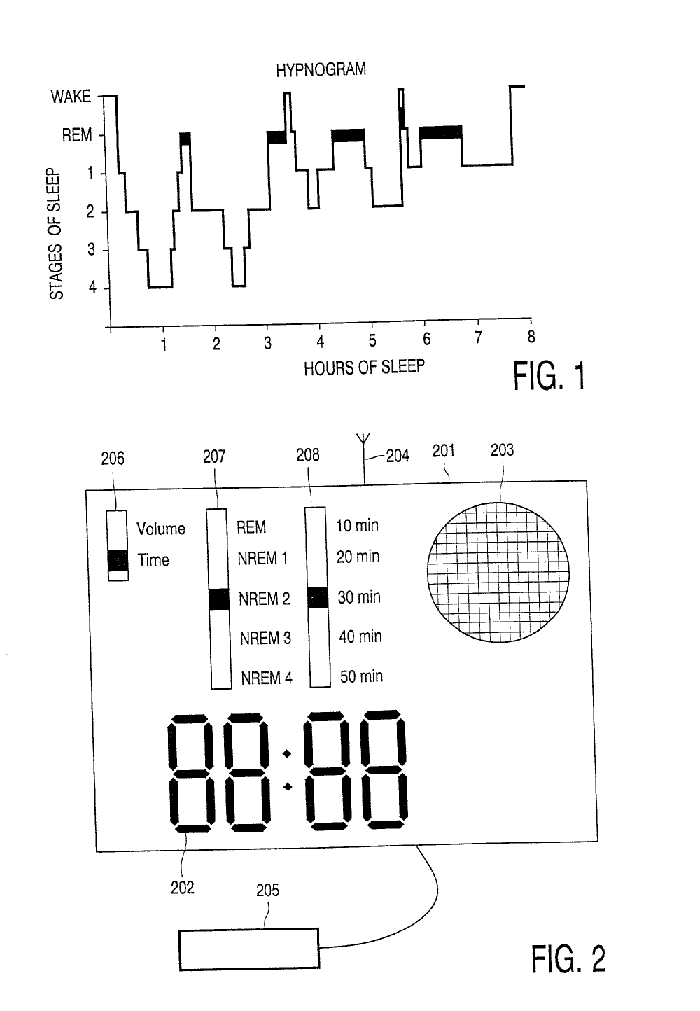

FIG. 1 shows a hypnogram, comprising sequences of states and stages of sleep on a typical night. The meaning of the various states and stages have already been discussed in the introduction.

FIG. 2 shows an alarm clock system as an example of a system according to the invention.

An alarm clock 201 comprises a segmented display for displaying a time value, i.e. the current time, or a wake-up time when this wake-up time is set. The alarm clock 201 further comprises alarm means 203, including a loudspeaker, for generating an auditory stimulus for waking the user. The user may choose whether said stimulus is a buzz, or a radio program. For this purpose, user operable selection means are provided (not shown). An antenna 204 is provided for receiving radio programs. A radio tuner, means for controlling the tuner and the sound volume, and means for setting the (wake-up) time are provided, but said means are conventional and are not shown in FIG. 2. The alarm clock system further comprises a thermometer 205, which is connected to the alarm clock 201. The alarm means 203 are capable of monitoring the user's stage of sleep, as discussed in the introduction of this application, with the aid of the thermometer 205. The alarm clock system may adapt attributes of the wake-up stimulus, according to said stage of sleep. In dependence on the state of a user operable switch 206, the alarm clock adjusts either the sound volume of the stimulus, or the time of generation of the stimulus. If the user has selected the sound volume and if the user is in NREM stage 3 or 4 at the wake-up time, the alarm clock 201 increases the sound volume with respect to the normal sound volume determined by the state of a user operable volume control. If the user is in another stage at the wake-up time, the normal volume is applied.

Switches 207 and 208 are only operational if the switch 206 is in the ‘time’ state. By means of the switch 207, the user can choose in which stage of sleep he wishes to be waked. He can choose from five states: REM, NREM stage 1, NREM stage 2, NREM stage 3 and NREM stage 4, which are described in the introduction.

By means of the switch 208 the user can set the length of the interval of time in which he wishes to be waked. If the interval is chosen to be thirty minutes, the alarm clock system can adjust the wake-up time within this interval, the end of which coincides with the user-selected wake-up time. If the desired stage of sleep is not detected during the interval, the user is waked anyway at the end of the interval, i.e. at the normal wake-up time.

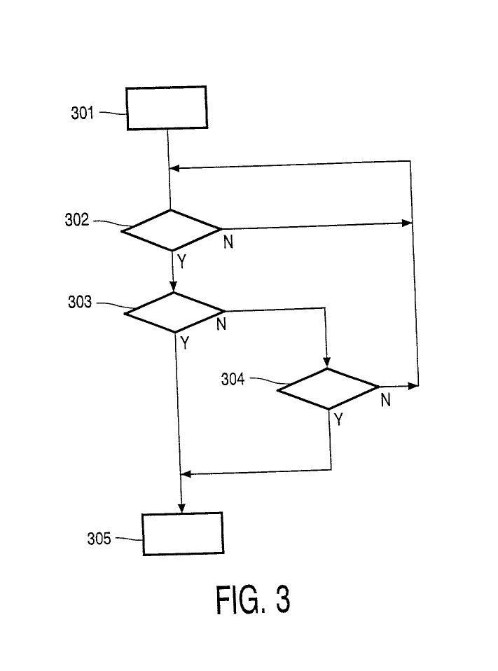

This process is depicted in FIG. 3. In an initial step 301, the alarm-clock system is activated. In a step 302 it is tested whether the wake-up interval has already begun. If this is the case, it is tested in a step 303 whether the user is in the stage of sleep during which he wishes to be waked. If this is the case, the user is actually waked in a step 305. If the user is not in the desired stage, it is tested in a step 304 whether the wake-up interval is about to end. If this is the case, the user is waked anyway, irrespective of the stage of sleep. In all other cases, the process repeats indefinitely.

Optionally, in a simultaneous process, the system monitors the user's body parameters, e.g. the body temperature, during the whole sleeping period, so as to obtain an accurate indication in which stage the user is at a particular moment. This is achieved by comparing the body parameters at various points in time, and comparing the results with a generic sleep model hypnogram and/or a history of statistics about the user's sleeping behavior.

In summary, the invention relates to an alarm clock system. The system according to the invention comprises sensor means for measuring ambient parameters. In particular, a user's body parameters are monitored so as to determine in which stage of sleep he is. Properties of the wake-up stimulus, such as sound volume of the stimulus or moment of generation of the stimulus, are adjusted in dependence on the inferred stage of sleep.

Although the invention has been described with reference to particular illustrative embodiments, variants and modifications are possible within the scope of the inventive concept. Thus, for example, instead of, or in addition to, body parameters, the system according to the invention may also take other ambient parameters into account, such as room temperature, light conditions, ambient noise etc. For example, if the ambient noise is high, the sound level of the wake-up stimulus may be increased. If the room temperature is very high or very low, the system may decide not to wake the user during REM sleep, because in that state, the body temperature is not regulated well, which might result in unpleasant feelings after waking up. Throughout this specification, the term ‘ambient’ has the meaning of ‘external to the waking system’, hence ambient parameters can be parameters of the user's body, or environmental parameters such as light conditions, background noise etc.

The use of the verb “to comprise” and its conjugations does not exclude the presence of the elements or steps other than those defined in a claim. The invention can be implemented by means of hardware comprising several distinct elements, and by means of a suitably programmed computer. In the device claim enumerating several means, several of these means can be embodied by one and the same item of hardware.

A ‘computer program’ is to be understood to mean any software product stored on a computer-readable medium, such as a floppy-disk, downloadable via a network, such as the Internet, or marketable in any other manner.

1. A system for waking a user, comprising alarm means for generating a stimulus for waking the user, characterized in that the system further comprises sensor means for measuring an ambient parameter, the alarm means being adapted to adjust at least one attribute of said stimulus on the basis of a value of said ambient parameter.

2. A system as claimed in claim 1, said stimulus comprising an auditory stimulus, said attribute being a sound level of said auditory stimulus.

3. A system as claimed in claim 1 or 2, said attribute being an instant of generating said stimulus, the alarm means being adapted to adjust said instant within a predetermined interval.

4. A system as claimed in any one of claims 1 to 3, the ambient parameter being a body parameter of the user.

5. A system as claimed in claim 4, said body parameter being representative of the user's stage of sleep.

6. A system as claimed in claim 5, said body parameter being the user's body temperature.

7. A system as claimed in claim 4 or 5, where dependent on claim 3, the system further comprising user operable means for determining during which stage of sleep the user is waked.

8. A system as claimed in claim 7, the system further comprising user operable means for setting the starting time and the end time of said predetermined interval.

9. An alarm clock for use in a system as claimed in any one of the claims 1 to 8, comprising alarm means for generating a stimulus for waking the user, characterized in that the alarm clock further comprises means for receiving from a sensor means a value of an ambient parameter, the alarm means being adapted to adjust at least one attribute of said stimulus on the basis of a value of said ambient parameter.

10. An alarm clock as claimed in claim 9, further comprising said sensor means.

11. A sensor means for use in a system as claimed in any of claims 1 to 8, the sensor means being capable of measuring a value of an ambient parameter, and of transferring the value to an alarm clock.

12. A computer program product for causing, when executed on a suitable computing device, said computing device to constitute a system as claimed in claims 1 to 8.
